(19) United States
(12) Patent Application Publication
(10) Pub. No.: US 2017/0066372 A1
(43) Pub. Date: Mar. 9, 2017

(54) LIGHTING DEVICE WITH ORGANIC LIGHT-EMITTING DIODE

(71) Applicant: Valeo Vision, Bobigny Cedex (FR)

(72) Inventors: Olivier Ruat, Trelaze (FR); Stephane Patrizi, Montreuil Juigne (FR); Pierre Albou, Paris (FR); Vincent Godbillon, Paris (FR)

(21) Appl. No.: 15/257,126

(22) Filed: Sep. 6, 2016

(30) Foreign Application Priority Data
Sep. 8, 2015 (FR) 1558337

(51) Int. Cl. B60Q 1/34; H05B 37/02; H05B 33/08

(52) U.S. Cl. CPC B60Q 1/343; H05B 33/0896; H05B 37/029

(57) ABSTRACT

A lighting device for automobile vehicle comprising a first module comprising a first surface light source, a second module comprising a second surface light source and a control module configured for controlling the first and second modules in such a manner that the lighting device performs a function of sequential direction indicator.

### CROSS-REFERENCE TO RELATED APPLICATIONS

This application claims priority to the French application 1558337, filed Sep. 8, 2015, which application is incorporated herein by reference and made a part hereof.

### BACKGROUND OF THE INVENTION

1. Field of the Invention

The invention relates to the field of lighting and signaling devices for automobile vehicles.

2. Description of the Related Art

As is known, this type of device is tending to get more complex owing to the increasing number of functions that these devices are designed to implement. Amongst these functions, the implementation of direction indicators of the sequential type may notably be mentioned. Furthermore, the need exists to give to these devices an esthetic character which notably contributes to defining the general appearance, or the “visual signature”, of the vehicle in question, and which differentiates it from other vehicles. For example, this esthetic character may take the form of a device whose emission surface extends in three dimensions.

### SUMMARY OF THE INVENTION

In this context, the invention aims to present a lighting device for automobile vehicles which allows the definition of a particular visual signature for this vehicle while at the same time having an optimized design, reliability and compactness.

For this purpose, the invention provides a lighting device for automobile vehicles, the lighting device comprising a first module comprising a first surface light source, notably a first organic light-emitting diode, a second module comprising a second surface light source, notably a second organic light-emitting diode, and a control module configured for controlling the first and second modules in such a manner that the lighting device performs a function of sequential direction indicator.

A “surface light source” is understood to mean a light source having a light-emitting surface whose thickness is negligible relative to the dimensions of this light-emitting surface.

If desired, the first surface light source may be a first organic light-emitting diode, or OLED, and the second surface light source may be a second organic light-emitting diode. If appropriate, the light-emission surface area for each OLED may be greater than 1 cm².

As a variant, each surface light source may be an illuminated panel formed by an assembly of optical fibers, notably juxtaposed, platted or tangled, the optical fibers being associated with one or more light sources, notably comprising one or more light-emitting diodes, or LEDs. Where desirable, the light source or sources may be configured to emit the light into the ends of the optical fibers, the optical fibers being arranged to diffuse this light via exit faces of these fibers formed over their envelope over the whole or a part of their length, the whole assembly of the exit faces thus forming the surface light source, also in this case known as a FOLED.

Where desirable, each organic light-emitting diode may be designed to emit light of amber color.

Advantageously, the control module is configured for controlling the first and second modules in such a manner that the organic light-emitting diodes are sequentially in an active configuration. The term ‘active configuration’ is understood to mean a configuration of the organic light-emitting diode in which light emitted by the diode exits from the device so as to participate in the function of sequential direction indicator.

According to one embodiment of the invention, each organic light-emitting diode is installed so as to be mobile, for example in rotation, within the lighting device. Advantageously, each module comprises an actuator associated with the organic light-emitting diode of the module in order to selectively bring the organic light-emitting diode into an inactive position, in which the emission face of the organic light-emitting diode is masked in such a manner that little or no light emitted by the organic light-emitting diode can exit from the lighting device, and into an active position, in which the emission face of the organic light-emitting diode is visible in such a manner that the light emitted by the organic light-emitting diode can exit from the lighting device so as to participate in the function of sequential direction indicator. Where appropriate, the control module is configured for controlling the actuators so as to sequentially bring each organic light-emitting diode into its active position, which thus forms the active configuration. Where required, the control module may be configured in such a manner that this sequential activation of the organic light-emitting diodes is implemented in less than 200 ms.

According to another alternative or cumulative embodiment of the invention, the control module is configured for controlling the illumination of the first and second modules in such a manner as to generate a sequential illumination of the first and second organic light-emitting diodes. For example, the control module is configured for controlling the alimentation of each organic light-emitting diode so as to illuminate or to extinguish this diode. Where desired, the active configuration of this diode is when it is illuminated.

Advantageously, the first and second modules are disposed in such a manner that the first organic light-emitting diode is disposed toward the interior of the vehicle and the second organic light-emitting diode is disposed toward the exterior of the vehicle, when the lighting device is installed in an automobile vehicle. Where desired, the control module is configured for illuminating the first organic light-emitting diode before the second organic light-emitting diode. Potentially, the control module may be configured so that the first organic light-emitting diode remains illuminated when the second organic light-emitting diode is illuminated. The control module thus implements a sequential and progressive illumination of the organic light-emitting diodes from the interior towards the exterior of the vehicle.

According to one embodiment of the invention, the first organic light-emitting diode is distinct from the second organic light-emitting diode. Where desired, each organic light-emitting diode comprises a pair of electrodes, these pairs of electrodes being distinct from one diode to another.

As a variant, the first and second organic light-emitting diodes may comprise a common electrode. Where desired, each organic light-emitting diode forms a separate segment of a single global organic light-emitting diode of the lighting device. For example, the global organic light-emitting diode has a first face comprising an electrode, for example an anode, continuous over its entire length, a second segmented face comprising an alternation of a plurality of second electrodes and of electrically-insulating strips, and a layer of organic material capable of emitting light disposed between the first and second faces. Each segment formed by a part of the first electrode, a part of the layer of organic material and a second electrode thus forms one of the organic light-emitting diodes. Where appropriate, the first electrode may be designed to allow light to pass through, for example by being transparent, and forms a light-emitting face of each organic light-emitting diode and each second electrode forms an installation face of each organic light-emitting diode. As a variant, the first face may also be segmented.

In one embodiment of the invention, the lighting device comprises at least one support comprising a mounting face extending in three directions perpendicular to one another, and at least one of the organic light-emitting diodes is installed on the mounting face of the support.

The mounting face thus has a developable surface extending in three dimensions. Advantageously, this mounting face may take the form of a curved surface. Where desired, the organic light-emitting diode has an installation face and a light-emitting face opposite to the installation face, the organic light-emitting diode being mounted onto the support via its installation face. The organic light-emitting diode may be configured in such a manner as to be able to emit light via its light-emitting face in a general direction substantially parallel to a normal to the mounting face.

Advantageously, the organic light-emitting diode is flexible. Preferably, the organic light-emitting diode is mounted onto the mounting face so as to exhibit a shape that is identical to that of the mounting face. Where desired, the organic light-emitting diode is mounted in such a manner that no play is present between the installation face of the diode and the mounting face of the support. In other words, the diode is mounted onto the support with no play.

In one embodiment of the invention, the organic light-emitting diode is bonded onto the mounting face, notably via its installation face. If it is desired, the light-emitting diode may be bonded onto the mounting face with the aid of a double-sided adhesive film. As a variant, the organic light-emitting diode may be bonded by means of an adhesive.

Advantageously, the device may comprise a positioning pin fixed to the organic light-emitting diode and which can be inserted into an orifice of the support. The positioning pin may for example be bonded to the installation face of the diode.

If it is desired, the positioning pin may be equipped with of a mechanism, for example a clip, for fixing the organic light-emitting diode to the support. Where desired, the device may be without adhesive connecting the diode to the support.

In another embodiment of the invention, the organic light-emitting diode is formed directly on the support. The device may, in this case, be lacking any means for fixing the organic light-emitting diode to the support. The organic light-emitting diode may for example be formed by a vacuum evaporation method on the support, including steps for metallization of the support and for depositions of organic light-emitting material and of an electrode, or by a printing method under the support.

Another subject of the invention is a method for controlling a lighting device according to the invention, characterized in that it comprises the following steps:

the first module is activated so that the light emitted by the first surface light source exits from the lighting device;

after the activation of the first module, the second module is activated so that the light emitted by the second surface light source exits from the lighting device.

These and other objects and advantages of the invention will be apparent from the following description, the accompanying drawings and the appended claims.

### BRIEF DESCRIPTION OF THE ACCOMPANYING DRAWINGS

The invention will be better understood upon reading the detailed description that follows, presented solely by way of example and with reference to the appended figures, in which:

FIG. 1 is a schematic and partial illustration of a lighting device according to the invention;

FIGS. 2A-2F are views of the lighting device in FIG. 1 implementing a method according to the invention;

FIG. 3 is a schematic and partial illustration of a lighting device according to another embodiment of the invention.

FIG. 4 illustrates an exploded view of the lighting device in FIG. 1 according to a first embodiment of the invention;

FIG. 5 is a cross-sectional view of the lighting device in FIG. 1 according to a second embodiment; and

FIG. 6 is a cross-sectional view of the lighting device in FIG. 1 according to a third embodiment.

### DETAILED DESCRIPTION OF THE PREFERRED EMBODIMENTS

FIG. 1 illustrates a lighting device 1 according to the invention.

The lighting device 1 comprises a global organic light-emitting diode or OLED 2. The OLED 2 has a first reflecting face 21 made of aluminum forming an anode of the OLED 2. The first reflecting face or anode 21 extends in a continuous manner over the entire length of the OLED 2.

The OLED 2 comprises a second face 22. The second face 22 is segmented; namely, it comprises an alternation of transparent cathodes 221 formed from indium-tin oxide, or ITO, and of electrically insulating strips 222.

Lastly, the OLED 2 comprises a layer 23 formed from a superposition of sub-layers of organic material capable of emitting light of amber color when they are electrically powered. The layer 23 is disposed between the first and second faces 21 and 22 in such a manner that a part of the light that it emits goes through the cathode 221 and the other part of this light is reflected by the anode 21 and also goes through the cathode 221.

Each superposition of a cathode 221, of a part of the layer 23 and of a part of the anode 21, situated opposite this cathode 221, forms a segment of the global OLED 2 which is selectively activatable. This segment thus itself forms an OLED whose light-emitting face is its transparent cathode 221 and whose anode 21 is common to the other segments. It goes without saying that the anode 21 could also be segmented.

The lighting device 1 thus comprises five modules 31 to 35, each formed by one of the segments of the global OLED 2.

The lighting device furthermore comprises a control module 4 connected, on the one hand, to each cathode 221 of the modules 31 to 35 by wires 41 to 45, and on the other, to the common anode 21 by a wire 46. The control module 4 can thus selectively power each of the modules 31 to 35, via the wires 41 to 45, so as to selectively illuminate the OLEDs 2 of these modules 31 to 35.

The control module 4 is here configured in the form of a microcontroller comprising a memory unit (not shown) in which a command is stored for sequential illumination of the modules 31 to 35 in order to implement a sequential direction indicator.

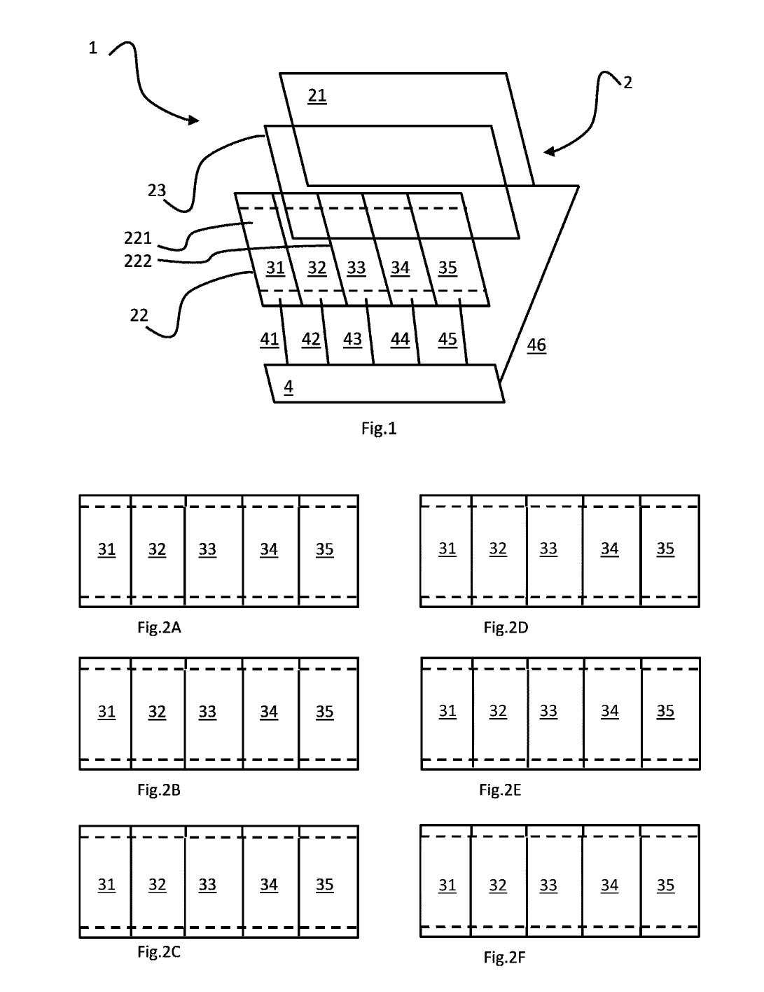

FIG. 2A shows the lighting device 1 when all the OLEDs 2 of the modules 31 to 35 are extinguished and in FIGS. 2B to 2F the illumination sequence for the implementation of the sequential direction indicator.

The modules 31 to 35 are disposed within the lighting device 1 in such a manner that the OLED 2 of the first module 31 is disposed toward the interior of the vehicle and the OLED 2 of the last module 35 is disposed toward the exterior of the vehicle, when the lighting device 1 is installed in an automobile vehicle.

When the control module 4 receives a command for initiation of the sequence for the implementation of the sequential direction indicator, the control module 4 first of all powers the module 31 in order to illuminate the OLED 2 of this module 31 (FIG. 2B). After a lapse of time of 200 ms or less, the control module 4 powers the module 32 in order to illuminate the first organic light-emitting diode or OLED 2 of this module 32, while at the same time continuing to power the module 31 (FIG. 2C). The control module 4 thus continues to sequentially illuminate the OLEDs 2 of the following modules 33 to 35 while at the same time keeping the OLEDs 2 of the preceding modules 31 to 32 illuminated (FIGS. 2D and 2E), until all the OLEDs 2 of the modules 31 to 35 are illuminated (FIG. 2F). The control module 4 thus implements a sequential and progressive illumination of the OLEDs 2 from the interior toward the exterior of the vehicle. Where desired, the visible light-emitting surface formed by the whole assembly of the illuminated OLEDs 2 is continuous. Furthermore, once all these OLEDs 2 are illuminated, the control module 4 simultaneously interrupts the power supply to all the OLEDs 2, then repeats the sequence until it receives a command to interrupt the sequence, and thus forms a regulation sequential direction indicator. For example, such as defined in the regulation UNECE N° 6 relating to direction indicators, Paragraph §5.6.

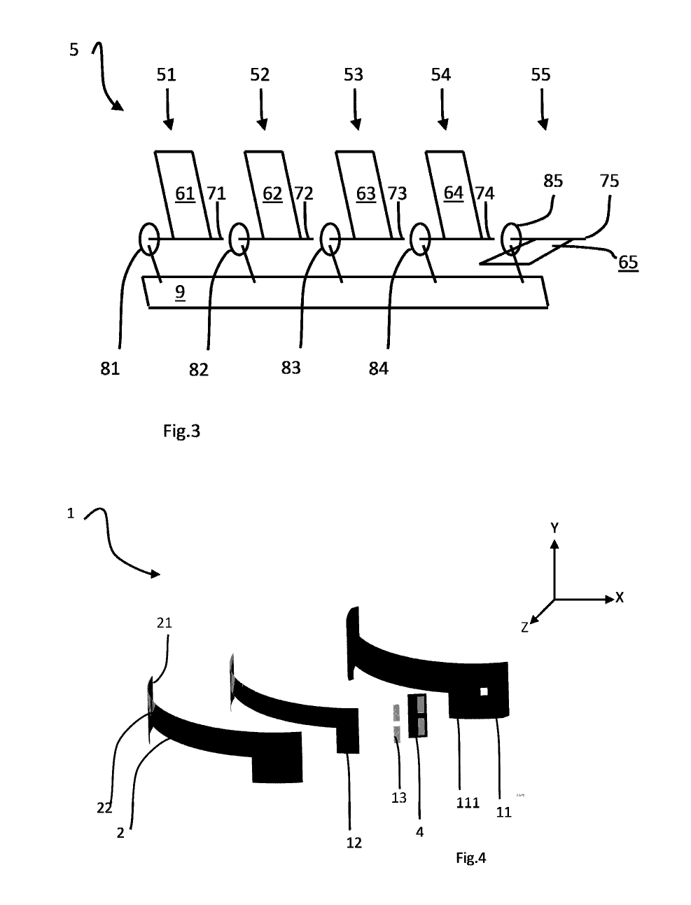

FIG. 3 shows a lighting device 5 according to another embodiment of the invention. The lighting device 5 comprises five lighting modules 51 to 55 each comprising an organic light-emitting diode OLED 61 to 65, the OLEDs 61 to 65 being distinct from one another.

Each OLED 61 to 65 is mounted so as to be rotatable about an axis 71 to 75, in the lighting device 5, and each module 51 to 55 comprises an actuator 81 to 85 associated with the OLED 61 to 65 of the module 51 to 55 in order to drive the axis 71 to 75 and selectively bring the OLED 61 to 65 into an inactive position (P) and into an active position (A). The OLED 65 is represented in its inactive position (P) where its emission face is masked in such a manner that little or no light that it emits can exit from the lighting device 5. The OLEDs 61 to 64 are shown in an active position, in which their emission face is visible in such a manner that the light that they emit can exit from the lighting device 5 so as to participate in the function of sequential direction indicator.

The lighting device 5 comprises a control module 9 which is configured for controlling the axis 71 to 75 so as to sequentially bring each organic light-emitting diode or OLED 61 to 65 into its active position.

FIG. 4 shows an exploded view of the lighting device 1 in FIG. 1, in which the segmentation of the global OLED 2 is not shown.

Aside from the global OLED 2 and the control module 4, the lighting device 1 comprises a support 11 comprising a mounting face 111 extending in three mutually perpendicular directions X, Y and Z in order to form a developable surface. The global OLED 2 is mounted onto the mounting face 111 of the support 11.

In the example shown, the mounting face 111 exhibits a cylindrical shape, without the invention being however limited to that one shape of developable surface.

The OLED 2 has an installation face 21 formed by the anode and a light-emitting face formed by the face 22, opposite to the installation face 21. The OLED 2 is flexible and is mounted onto the mounting face 111 so as to conform to the profile of this mounting face 111 and thus to have a shape identical to that of this mounting face 111. Furthermore, owing to the developable shape of the mounting face 111, the OLED 2 is mounted onto the support 11 without any play.

The OLED 2 is bonded onto the mounting face 111 by means of a double-sided adhesive film 12. Furthermore, the control module 4 is also mounted onto the mounting face 111 by means of a double-sided adhesive film 13.

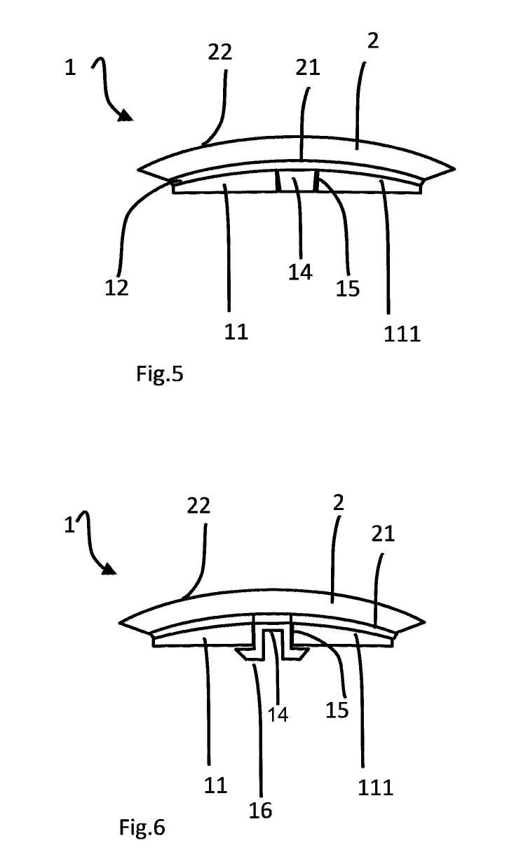

FIG. 5 shows one variant of the embodiment in FIG. 4. The references for the elements that are identical between these two embodiments will be conserved.

The lighting device 1 comprises a positioning pin 14 fixed, in a previous step, to the installation face 21 of the OLED 2 by the double-sided adhesive film 12. The positioning pin 14 is inserted into an orifice 15 of the support 11 so as to position the OLED 2 in a predetermined position on this support 11.

FIG. 6 shows another variant of the embodiment in FIG. 4. The references for the elements that are identical between these two embodiments will be conserved.

In this embodiment, the positioning pin 14 is equipped with a clip 16 allowing, over and above its positioning function, the OLED 2 to be rigidly attached to the support 11. This fixing mode thus allows the double-sided adhesive film 13 in FIG. 4 connecting the OLED 2 to the support 11 to be eliminated.

The invention is not of course limited to the embodiments presented, and other embodiments could be clearly apparent to those skilled in the art without straying from the scope of the present invention.

While the system, apparatus, process and method herein described constitute preferred embodiments of this invention, it is to be understood that the invention is not limited to this precise system, apparatus, process and method, and that changes may be made therein without departing from the scope of the invention which is defined in the appended claims.

What is claimed is:

1. A lighting device for automobile vehicles, lighting device comprising a first module comprising a first surface light source, a second module comprising a second surface light source and a control module configured for controlling said first and second modules in such a manner that said lighting device performs a function of sequential direction indicator.

2. The lighting device according to the claim 1, in which said first surface light source is a first organic light-emitting diode and said second surface light source is a second organic light-emitting diode.

3. The lighting device according to claim 2, in which said control module is configured for controlling said first and second modules in such a manner that said first and second organic light-emitting diodes are sequentially in an active configuration.

4. The lighting devices according to claim 3, in which each organic light-emitting diode is mounted in a mobile manner within said lighting device, in which each module comprises an actuator associated with said organic light-emitting diode of -said module for selectively bringing said organic light-emitting diode into an inactive position and into an active position, and in which said control module is configured for controlling said actuator so as to sequentially bring each organic light-emitting diode into its active position.

5. The lighting device according to claim 3, in which said control module is configured for controlling an illumination of said first and second modules so as to implement a sequential illumination of said first and second organic light-emitting diodes.

6. The lighting devices according to claim 5, in which said first and second modules are disposed in such a manner that said first organic light-emitting diode is disposed toward an interior of the vehicle and said second organic light-emitting diode is disposed toward an exterior of the vehicle, in which said control module is configured for illuminating said first organic light-emitting diode before said second organic light-emitting diode.

7. The lighting device according to claim 2, in which said first organic light-emitting diode is distinct from said second organic light-emitting diode.

8. The lighting device according to claim 2, in which said first and second organic light-emitting diodes comprise a common electrode.

9. A method for controlling a lighting device according to claim 1, wherein said method comprises the following steps:
said first module is activated so that the light emitted by said first surface light source exits from said lighting device;
after the activation of said first module, said second module is activated so that the light emitted by said second surface light source exits from said lighting device.

10. The lighting device according to claim 4, in which said control module is configured for controlling an illumination of said first and second modules so as to implement a sequential illumination of said first and second organic light-emitting diodes.

11. The lighting device according to claim 3, in which said first organic light-emitting diode is distinct from said second organic light-emitting diode.

12. The lighting device according to claim 4, in which said first organic light-emitting diode is distinct from said second organic light-emitting diode.

13. The lighting device according to claim 5, in which said first organic light-emitting diode is distinct from said second organic light-emitting diode.

14. The lighting device according to claim 6, in which said first organic light-emitting diode is distinct from said second organic light-emitting diode.

15. The lighting device according to claim 3, in which said first and second organic light-emitting diodes comprise a common electrode.

16. The lighting device according to claim 4, in which said first and second organic light-emitting diodes comprise a common electrode.

17. The lighting device according to claim 5, in which said first and second organic light-emitting diodes comprise a common electrode.

18. The lighting device according to claim 6, in which said first and second organic light-emitting diodes comprise a common electrode.

19. The lighting device according to claim 7, in which said first and second organic light-emitting diodes comprise a common electrode.

20. A method for controlling a lighting device according to claim 2, wherein said method comprises the following steps:
said first module is activated so that the light emitted by said first surface light source exits from said lighting device;
after the activation of said first module, said second module is activated so that the light emitted by said second surface light source exits from said lighting device.
